(19) United States
(12) Patent Application Publication
(10) Pub. No.: US 2026/0252340 A1
(43) Pub. Date: Aug. 27, 2026

(54) SECURE FIRMWARE UPDATE ON OUT-OF-ORDER DATA DELIVERY

(71) Applicant: Micron Technology, Inc., Boise, ID (US)

(72) Inventors: Angelo Alberto Rovelli, Agrate Brianza (IT); Federica Cresci, Milano (IT)

(21) Appl. No.: 19/548,524

(22) Filed: Feb. 24, 2026

Related U.S. Application Data
(60) Provisional application No. 63/763,747, filed on Feb. 26, 2025.

(51) Int. Cl. G06F 8/654; G06F 21/57

(52) U.S. Cl. CPC G06F 8/654; G06F 21/572; G06F 2221/033

(57) ABSTRACT

Devices and techniques that provide a secure firmware updates with out-of-order data delivery are described herein. A device comprises: a temporary memory to store firmware images; and controller circuitry configured to: receive into a buffer memory, from a host device, a plurality of data fragments, the plurality of data fragments having an initial order that is different from the order received at the device, and the plurality of data fragments constituting a firmware image; generate an ordered list of fragments using metadata stored in the plurality of data fragments; generate a data transfer control list including an entry for each of the plurality of data fragments; and execute commands to transfer the plurality of data fragments from the buffer memory to the temporary memory using the data transfer control list.

### PRIORITY APPLICATION

This application claims the benefit of priority to U.S. Provisional Application Ser. No. 63/763,747, filed Feb. 26, 2025, which is incorporated herein by reference in its entirety.

### BACKGROUND

Memory devices are typically provided as internal, semiconductor, integrated circuits in computers or other electronic devices. There are many diverse types of memory including volatile and non-volatile memory. Volatile memory can require power to maintain data and includes random-access memory (RAM), dynamic random-access memory (DRAM), and synchronous dynamic random-access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random-access memory (RRAM), and magnetoresistive random access memory (MRAM), 3D XPoint™ memory, among others.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system.

Various protocols or standards can be applied to facilitate communication between a host and one or more other devices (e.g., memory buffers, accelerators, or other input/output devices). In an example, an unordered protocol such as Compute Express Link (CXL) can be used to provide high-bandwidth and low-latency connectivity.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

To easily identify the discussion of any particular element or act, the most significant digit or digits in a reference number refer to the figure number in which that element is first introduced.

FIG. 1 is a block diagram illustrating an example of a computing system including a host device and a memory system, according to an embodiment.

FIG. 2 is a block diagram illustrating an example of a CXL system that uses a bus system, including a CXL link bus and a system management bus (SMBus), to connect a host device and a CXL device, according to an embodiment.

FIGS. 3A-3B are block diagrams illustrating the deconstruction and reconstruction of a firmware image, according to an embodiment.

FIG. 4 is a block diagram illustrating a data structure of a fragment control word (FCW), according to an embodiment.

FIG. 5 is a block diagram illustrating a process for generating a unique tag (UT) for an Nth fragment, according to an embodiment

FIG. 6 is a block diagram illustrating a data structure of an ordered fragment transfer unit (FTU) list (OFL), according to an embodiment.

FIG. 7 is a block diagram illustrating a data structure of a data transfer control list (DTCL) entry, according to an embodiment.

FIG. 8 is a swim lane diagram illustrating data and control flow of a method to manage out-of-order data transfer, according to an embodiment.

FIG. 9 is a flowchart illustrating an example method for managing firmware programming in a device, according to an embodiment.

FIG. 10 illustrates a block diagram of an example machine with which, in which, or by which any one or more of the techniques (e.g., methodologies) discussed herein can be implemented.

### DETAILED DESCRIPTION

Aspects of the present disclosure are directed to firmware updates that are received over a channel that does not guarantee that segments are received in the order that they were transmitted. Firmware (FW) is software that is used for low-level control of hardware components, such as video cards, hard disk drives (HDD), solid state drives (SSD), processors, interface hubs, network interface devices (NID), and the like. Each hardware component includes one or more device controllers. Firmware is stored in memory accessible by a device controller. In conventional implementations, FW is stored in non-volatile memory. Firmware may be updated by the host system.

The FW may be transferred over an interconnect bus from a host system to a device. Compute Express Link (CXL) is an open standard interconnect configured for high-bandwidth, low-latency connectivity between host devices and other devices such as accelerators, memory buffers, and other I/O devices. CXL was designed to facilitate high-performance computational workloads by supporting heterogeneous processing and memory systems. CXL enables coherency and memory semantics on top of PCI Express (PCIe)-based I/O semantics for optimized performance.

In some examples, CXL is used in applications such as artificial intelligence, machine learning, analytics, cloud infrastructure, edge computing devices, communication systems, and elsewhere. Data processing in such applications can use various scalar, vector, matrix, and spatial architectures that can be deployed in CPU, GPU, FPGA, smart NICs, or other accelerators that can be coupled using a CXL link.

CXL supports dynamic multiplexing using a set of protocols that includes input/output (CXL. io, based on PCIe), caching (CXL. cache), and memory (CXL. memory or CXL. mem) semantics. In an example, CXL can be used to maintain a unified, coherent memory space between the CPU (e.g., a host device or host processor) and any memory on the attached CXL device. This configuration allows the CPU and the CXL device to share resources and operate on the same memory region for higher performance, reduced data movement, and reduced software stack complexity. In an example, the CPU is primarily responsible for maintaining or managing coherency in a CXL environment. Accordingly, CXL can be leveraged to help reduce device cost and complexity, as well as overhead traditionally associated with coherency across an I/O link.

CXL runs on PCIe PHY and provides full interoperability with PCIe. In an example, a CXL device starts link training in a PCIe Gen 1 Data Rate and negotiates CXL as its operating protocol (e.g., using the alternate protocol negotiation mechanism defined in the PCIe 5.0 Specification) if its link partner supports CXL. Devices and platforms can thus more readily adopt CXL by leveraging the PCIe infrastructure without having to design and validate the PHY, channel, channel extension devices, or other upper layers of PCIe.

In an example, CXL supports single-level switching to enable fan-out to multiple devices. This enables multiple devices in a platform to migrate to CXL, while maintaining backward compatibility and the low-latency characteristics of CXL. In an example, CXL can provide a standardized compute fabric that supports pooling of multiple logical devices (MLD) and single logical devices such as using a CXL switch connected to several host devices or nodes (e.g., Root Ports). This feature enables servers to pool resources such as accelerators and/or memory that can be assigned according to workload. For example, CXL can help facilitate resource allocation or dedication and release. In an example, CXL can help allocate and deallocate memory to various host devices according to need. This flexibility helps designers avoid over-provisioning while ensuring best performance.

A CXL device uses a FW slot to store the FW image. To apply a new FW to the device, the operations involve downloading the FW into the slot and then activating the slot. Once the FW image is downloaded to the FW slot, it stays persistent on the CXL device across power cycles.

When transferring a FW image from the host to the CXL device, the FW image is divided into a number of segments, and the segments are transmitted from the host to the CXL device. The transfer is typically performed on a sideband channel, such as Inter-Integrated Circuit (I2C) or System Management Bus (SMBus). Because the sideband channel is typically a low-speed channel, in order to improve the efficiency of the FW update process, data transfer may be handled by multiple concurrent tasks, each of which is dedicated to the transfer one or more segments of the FW image. However, due to the concurrent execution of the tasks, the segments may be received out-of-order (OOO) at the CXL device. If the memory controller at the CXL device were to operate on an image reconstructed using the OOO segments, an error would result. As such, there is a need for preprocessing the OOO segments to rearrange them to their original order before any further processing on the FW image can be performed.

The present systems and methods described herein provide for a memory controller that is capable of a scatter/gather mechanism. The scatter/gather mechanism is used to transfer and merge non-contiguous memory to a continuous address space. Data segments are divided into a number of fragments. A descriptor referred to as a fragment control word (FCW) is determined and stored with each fragment. The memory controller uses fragment descriptors stored in the fragments that are sent to the CXL device to reorder the fragments and segments. Additional details are set forth below.

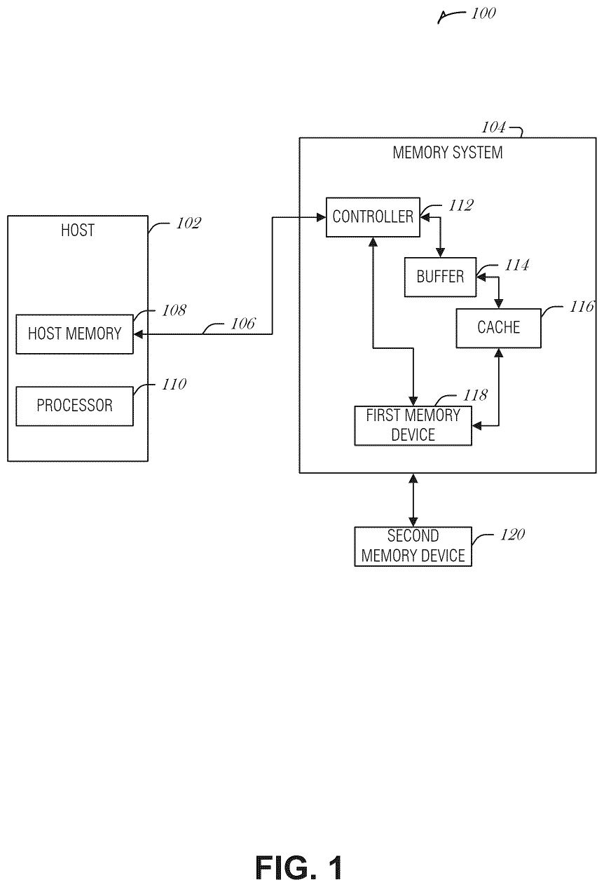

FIG. 1 is a block diagram illustrating an example of a computing system 100 including a host device 102 and a memory system 104, according to an embodiment. The host device 102 includes a central processing unit (CPU) or processor 110 and a host memory 108. In an example, the host device 102 can include a host system such as a personal computer, a desktop computer, a digital camera, a smart phone, a memory card reader, and/or Internet-of-things enabled device, among various other types of hosts, and can include a memory access device, e.g., the processor 110. The processor 110 can include one or more processor cores, a system of parallel processors, or other CPU arrangement.

The memory system 104 includes a controller 112, a buffer 114, a cache 116, and a first memory device 118. The first memory device 118 can include, for example, one or more memory modules (e.g., single in-line memory modules, dual in-line memory modules, etc.). The first memory device 118 can include volatile memory and/or non-volatile memory, and can include a multiple-chip device that comprises one or multiple different memory types or modules. In an example, the computing system 100 includes a second memory device 120 that interfaces with the memory system 104 and the host device 102.

The host device 102 can include a system backplane and can include a number of processing resources (e.g., one or more processors, microprocessors, or some other type of controlling circuitry). The computing system 100 can optionally include separate integrated circuits for the host device 102, the memory system 104, the controller 112, the buffer 114, the cache 116, the first memory device 118, the second memory device 120, any one or more of which may comprise respective chiplets that can be connected and used together. In an example, the computing system 100 includes a server system and/or a high-performance computing (HPC) system and/or a portion thereof. Although the example shown in FIG. 1 illustrates a system having a Von Neumann architecture, embodiments of the present disclosure can be implemented in non-Von Neumann architectures, which may not include one or more components (e.g., CPU, ALU, etc.) often associated with a Von Neumann architecture.

In an example, the first memory device 118 can provide a main memory for the computing system 100, or the first memory device 118 can comprise accessory memory or storage for use by the computing system 100. In an example, the first memory device 118 or the second memory device 120 includes one or more arrays of memory cells, e.g., volatile and/or non-volatile memory cells. The arrays can be flash arrays with a NAND architecture, for example. Embodiments are not limited to a particular type of memory device. For instance, the memory devices can include RAM, ROM, DRAM, SDRAM, PCRAM, RRAM, flash memory, among others.

In embodiments in which the first memory device 118 includes persistent or non-volatile memory, the first memory device 118 can include a flash memory device such as a NAND or NOR flash memory device. The first memory device 118 can include other non-volatile memory devices such as non-volatile random-access memory devices (e.g., NVRAM, ReRAM, FeRAM, MRAM, PCM), memory devices such as a ferroelectric RAM device that includes ferroelectric capacitors that can exhibit hysteresis characteristics, a 3-D Crosspoint (3D XP) memory device, etc., or combinations thereof.

In an example, the controller 112 comprises a media controller such as a non-volatile memory express (NVMe) controller. The controller 112 can be configured to perform operations such as copy, write, read, error correct, etc. for the first memory device 118. In an example, the controller 112 can include purpose-built circuitry and/or instructions to perform various operations. That is, in some embodiments, the controller 112 can include circuitry and/or can be configured to perform instructions to control movement of data and/or addresses associated with data such as among the buffer 114, the cache 116, and/or the first memory device 118 or the second memory device 120.

In an example, at least one of the processor 110 and the controller 112 comprises a command manager (CM) for the memory system 104. The CM can receive, such as from the host device 102, a read command for a particular logic row address in the first memory device 118 or the second memory device 120. In some examples, the CM can determine that the logical row address is associated with a first row based at least in part on a pointer stored in a register of the controller 112. In an example, the CM can receive from the host device 102, a write command for a logical row address, and the write command can be associated with second data. In some examples, the CM can be configured to issue, to non-volatile memory and between issuing the read command and the write command, an access command associated with the first memory device 118 or the second memory device 120. In some examples, the CM can issue, to the non-volatile memory and between issuing the read command and the write command, an access command associated with the first memory device 118 or the second memory device 120.

In an example, the buffer 114 comprises a data buffer circuit that includes a region of a physical memory used to temporarily store data, for example, while the data is moved from one place to another. The buffer 114 can include a first-in, first-out (FIFO) buffer in which the oldest (e.g., the first-in) data is processed first. In various embodiments, the buffer 114 includes a hardware shift register, a circular buffer, or a list.

In an example, the cache 116 comprises a region of a physical memory used to temporarily store particular data that is likely to be used again. The cache 116 can include a pool of data entries. In some examples, the cache 116 can be configured to operate according to a write-back policy in which data is written to the cache without being concurrently written to the first memory device 118. Accordingly, in some embodiments, data written to the cache 116 may not have a corresponding data entry in the first memory device 118.

In an example, the controller 112 can receive write requests (e.g., from the host device 102) involving the cache 116 and cause data associated with each of the write requests to be written to the cache 116. In some examples, the controller 112 can receive the write requests at a rate of thirty-two (32) gigatransfers (GT) per second, such as according to or using a CXL protocol. The controller 112 can similarly receive read requests and cause data stored in, e.g., the first memory device 118 or the second memory device 120, to be retrieved and written to, for example, the host device 102 via an interface 106.

In an example, the interface 106 can include any type of communication path, bus, or the like that allows information to be transferred between the host device 102 and the memory system 104. Non-limiting examples of interfaces can include a peripheral component interconnect (PCI) interface, a peripheral component interconnect express (PCIe) interface, a serial advanced technology attachment (SATA) interface, and/or a miniature serial advanced technology attachment (mSATA) interface, among others. In an example, the interface 106 includes a PCIe 5.0 interface that is compliant with the compute express link (CXL) protocol standard. Accordingly, in some embodiments, the interface 106 supports transfer speeds of at least 32 GT/s.

As similarly described elsewhere herein, CXL is a high-speed central processing unit (CPU)-to-device or CPU-to-memory interconnect designed to enhance compute performance. CXL technology maintains memory coherency between a CPU memory space (e.g., the host memory 108) and memory on attached devices or accelerators (e.g., the first memory device 118 or the second memory device 120), which allows resource sharing for higher performance, reduced software stack complexity, and lower overall system cost. CXL is designed to be an industry open standard interface for high-speed communications as accelerators are increasingly used to complement CPUs in support of emerging data-rich and compute-intensive applications such as artificial intelligence and machine learning.

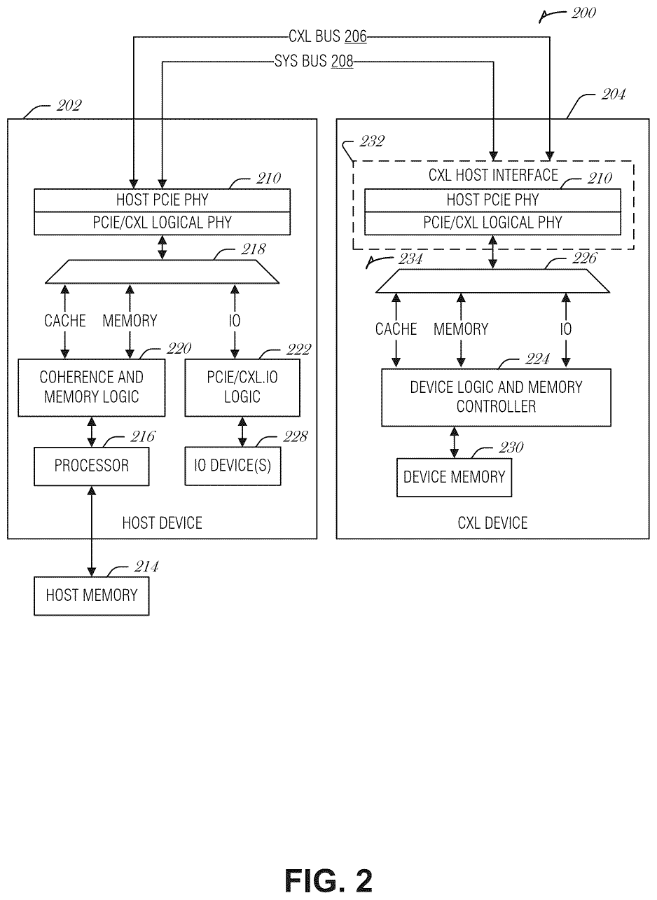

FIG. 2 is a block diagram illustrating an example of a CXL system 200 that uses a bus system, including a CXL link bus 206 and a system management bus (SMBus) 208, to connect a host device 202 and a CXL device 204, according to an embodiment. In an example, the host device 202 comprises or corresponds to the host device 102 and the CXL device 204 comprises or corresponds to the memory system 104 from the example of the computing system 100 in FIG. 1. A memory system command manager (CM) can comprise a portion of the host device 202 or the CXL device 204.

In an example, the SMBus 208 (e.g., corresponding to a portion of the interface 106 from the example of FIG. 1) is configured to support sideband communications between the host device 202 and the CXL device 204.

In an example, the CXL link bus 206 (e.g., corresponding to a portion of the interface 106 from the example of FIG. 1) can support communications using multiplexed protocols for caching (e.g., CXL. cache), memory accesses (e.g., CXL.mem or CXL.memory), and data input/output transactions (e.g., CXL.io). CXL.io can include a protocol based on PCIe that is used for functions such as device discovery, configuration, initialization, I/O virtualization, and direct memory access (DMA) using non-coherent load-store, producer-consumer semantics. CXL.cache can enable a device to cache data from the host memory (e.g., from the host memory 214) using a request and response protocol. CXL.memory can enable the host device 202 to use memory attached to the CXL device 204, for example, in or using a virtualized memory space. The CXL-based memory device can include or use a volatile or non-volatile memory such that it can be characterized by different speeds or latencies. In an example, the CXL-based memory device can include a CXL-based memory controller configured to manage transactions with the volatile or non-volatile memory.

In an example, CXL.memory transactions can be memory load and store operations that run downstream from or outside of the host device 202. CXL memory devices can have different levels of complexity. For example, a simple CXL memory system can include a CXL device that includes, or is coupled to, a single media controller, such as a memory controller (MEMC). A moderate CXL memory system can include a CXL device that includes, or is coupled to, multiple media controllers. A complex CXL memory system can include a CXL device that includes, or is coupled to, a cache controller (and its attendant cache) and to one or more media or memory controllers.

In the example of FIG. 2, the host device 202 includes a host processor 216 (e.g., comprising one or more CPUs or cores) and IO device(s) 228. The host device 202 can comprise, or can be coupled to, host memory 214. The host device 202 can include various circuitry or logic configured to facilitate CXL-based communications and transactions with the CXL device 204. For example, the host device 202 can include coherence and memory logic 220 configured to implement transactions according to CXL.cache and CXL.memory semantics, and the host device 202 can include PCIe logic 222 configured to implement transactions according to CXL.io semantics. In an example, the host device 202 can be configured to manage coherency of data cached at the CXL device 204 using, e.g., its coherence and memory logic 220.

The host device 202 can further include a host multiplexer 218 configured to modulate communications over the CXL link bus 206 (e.g., using the PCIe PHY layer). The multiplexing of protocols ensures that latency-sensitive protocols (e.g., CXL.cache and CXL.memory) have the same or similar latency as a native processor-to-processor link. In an example, CXL defines an upper bound on response times for latency-sensitive protocols to help ensure that device performance is not adversely impacted by variation in latency between different devices implementing coherency and memory semantics.

In an example, symmetric cache coherency protocols can be difficult to implement between host processors because different architectures may use different solutions, which in turn can compromise backward compatibility. CXL can address this problem by consolidating the coherency function at the host device 202, such as using the coherence and memory logic 220.

The CXL device 204 can include various components or logical blocks including a CXL host interface 232 and a device management system 234. In an example, the CXL host interface 232 can be configured to receive and manage various requests and transactions. For example, the CXL host interface 232 can be configured to receive and communicate PCIe resets such as using PERST (PCI Express Reset), Hot Reset, FLR (function level reset), and CXL resets. In an example, the CXL host interface 232 can be configured to receive and communicate DOE Transaction layer packets. In an example, the CXL host interface 232 can be configured to handle sideband requests or other miscellaneous events from PCIe and CXL devices, such as using the CXL link bus 206 or the system management bus 208.

The CXL host interface 232 can include or use multiple CXL interface physical layers 212. The device management system 234 can include, among other things, the device logic and memory controller 224. In an example, the CXL device 204 can comprise a device memory 230, or can be coupled to another memory device. The CXL device 204 can include various circuitry or logic configured to facilitate CXL-based communications and transactions with the host device 202 using the CXL link bus 206. For example, the device logic and memory controller 224 can be configured to implement transactions received using the CXL host interface 232 according to CXL.cache, CXL.memory, and CXL.io semantics. The CXL device 204 can include a CXL device multiplexer 226 configured to control communications over the CXL link bus 206.

In an example, one or more of the coherence and memory logic 220, the device management system 234, and the device logic and memory controller 224 comprises a Unified Assist Engine (UAE) or compute fabric with various functional units such as a command manager (CM), Threading Engine (TE), Streaming Engine (SE), Data Manager or data mover (DM), Advanced Encryption Standard (AES) engine, or other units. The compute fabric can be reconfigurable and can include separate synchronous and asynchronous flows.

The device management system 234 or the device logic and memory controller 224 or portions thereof can be configured to operate in an application space of the CXL system 200 and, in some examples, can initiate its own threads or sub-threads, which can operate in parallel and can optionally use resources or units on other CXL devices 204. Queue and transaction control through the system can be coordinated by the CM, TE, SE, DM, or AES engine components of the UAE. In an example, each queue or thread can map to a different loop iteration to thereby support multi-dimensional loops. With the capability to initiate such nested loops, among other capabilities, the system can realize significant time savings and latency improvements for compute-intensive operations.

In an example, command fencing can be used to help maintain order throughout such operations, which can be performed locally or throughout a compute space of the device logic and memory controller 224. In some examples, the CM can be used to route commands to a particular command execution unit (e.g., comprising the device logic and memory controller 224 of a particular instance of the CXL device 204) using an unordered interconnect that provides respective transaction identifiers (TID) to command and response message pairs.

In an example, the CM can coordinate a synchronous flow, such as using an asynchronous fabric of the reconfigurable compute fabric to communicate with other synchronous flows and/or other components of the reconfigurable compute fabric using asynchronous messages. For example, the CM can receive an asynchronous message from a dispatch interface and/or from another flow controller instructing a new thread at or using a synchronous flow. The dispatch interface may interface between the reconfigurable compute fabric and other system components. In some examples, a synchronous flow may send an asynchronous message to the dispatch interface to indicate completion of a thread.

Asynchronous messages can be used by synchronous flows such as to access memory. For example, the reconfigurable compute fabric can include one or more memory interfaces. Memory interfaces are hardware components that can be used by a synchronous flow or components thereof to access an external memory that is not part of the synchronous flow but is accessible to the host device 202 or the CXL device 204. A thread executed using a synchronous flow can include sending a read and/or write request to a memory interface. Because reads and writes are asynchronous, the thread that initiates a read or write request to the memory interface may not receive the results of the request. Instead, the results of a read or write request can be provided to a different thread executed at a different synchronous flow. Delay and output registers in one or more of the CXL devices 204 can help coordinate and maximize efficiency of a first flow, for example, by precisely timing engagement of particular compute resources of one device with arrival of data relevant to the first flow. The registers can help enable the particular compute resources of the same resource to be repurposed for flows other than the first flow, for example while the first flow dwells or waits for other data or operations to complete. Such other data or operations can depend on one or more other resources of the fabric.

Firmware (FW) updates can be performed in production, manufacturing, distribution, testing, or in the field to update a device's firmware. A FW update may be made secure by encrypting the FW image before transmitting it between the host device 202 and the CXL device 204. The FW resides in host memory 214 (optionally in encrypted form) and transferred to memory 230 of the CXL device 204, where it is decrypted (if encrypted), validated, and encrypted with a different key before storing it at the device in non-volatile memory (NVM). The host device 202 may use a plurality of asynchronous threads to transfer the FW image, which may introduce an out-of-order receipt at the CXL device 204. In order to address this issue, the host device 202 first deconstructs the FW image into a list of fragments, adds metadata to each fragment indicating its position in the list of ordered fragments, and then transmits the fragments with their metadata to the CXL device 204. The CXL device 204 can then confirm that all fragments have been received, reorder the fragments into their original order, and then perform the decryption (if needed), validation, and other processes on the FW image.

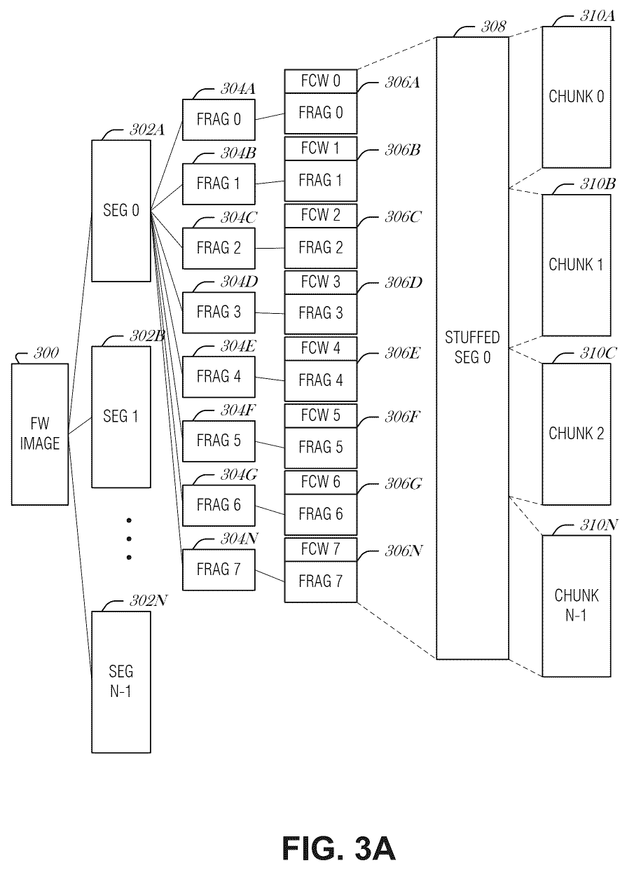

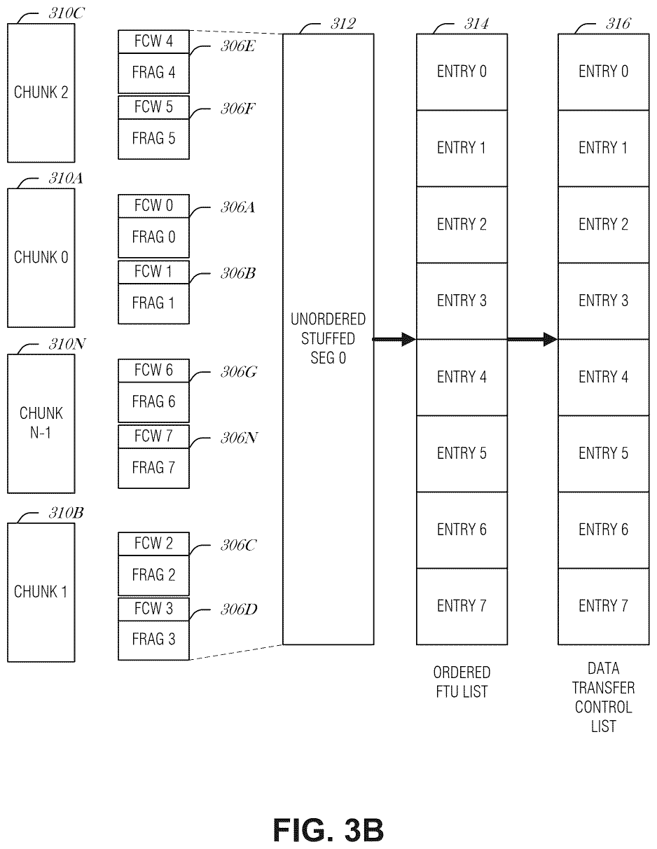

FIG. 3A is a block diagram illustrating the deconstruction of a firmware image 300, according to an embodiment. A firmware (FW) image 300 is divided into one or more segments 302A-N. A segment 302A is further divided into a plurality of fragments 304A-N. In an embodiment, the number of fragments 304 per segment 302 is eight. In another embodiment, the number of fragments 304 per segment 302 is determined during a handshake process between the host and the CXL device. In other embodiments, the number of fragments 304 per segment 302 is a value that is based on a maximum size of data that is transmitted between the host and the CXL device on a sideband channel.

Each fragment 304 is analyzed and a fragment control word (FCW) is determined and combined with the fragment 304. This FCW is a header or descriptor that includes metadata about the fragment 304. Together, the fragment 304 and its corresponding FCW is referred to as a fragment transfer unit (FTU) 306A-N. The FTUs 306 for a segment 302 constitute a stuffed segment 308. The stuffed segment 308 is then divided into a number of chucks 310A-D. The size of the chunks 310 may be limited by the amount of data that is able to be passed in one message between the host and the CXL device. One or more fragments 304 may be stored in each chunk 310A-N. If there is a misalignment between fragment size and chuck size, filler data may be used to fill the chunk 310. Partial FTUs 306 are not stored in a chunk 310.

For the purposes of illustration, the segment 302 is divided into eight fragments 304, and each chunk 310 carries two FTUs 306 of the stuffed segment 308. It is understood that there may be more FTUs 306 per chunk 310, and/or that the segment 302 may be divided into more or fewer than eight fragments 304.

FIG. 3B is a block diagram illustrating the reconstruction of a firmware image 300, according to an embodiment. Continuing from FIG. 3A, the chunks 310 are received at the CXL device out of order. The chunks 310 are received in a receive buffer. The receive buffer may be a portion of device memory 230. The chunks 310 are resolved into their constituent FTUs 306. The collection of unordered FTUs 306 represents an unordered segment 312. The unordered segment 312 is analyzed to determine the positions of the FCWs in the FTUs 306, and build an ordered FTU list (OFL) 314. This OFL 314 is then analyzed to build a data transfer control list (DTCL) 316. The DTCL 316 is used by a controller to transfer data from the receive buffer to the destination addresses in NVM.

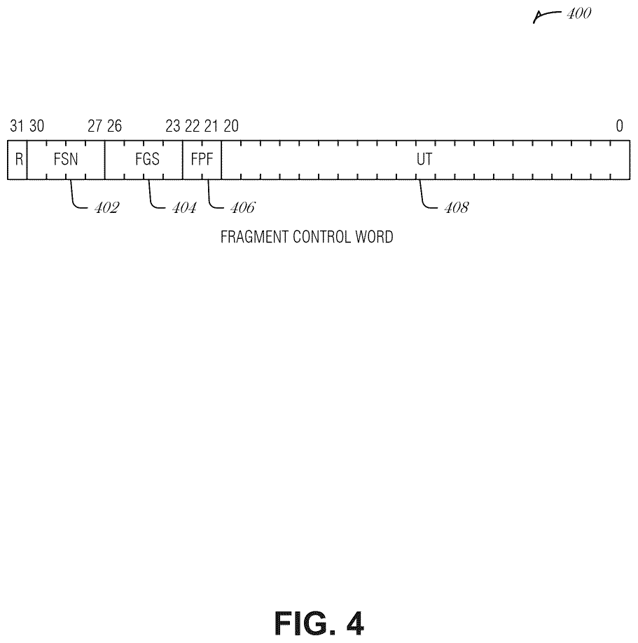

FIG. 4 is a block diagram illustrating a data structure of a fragment control word (FCW) 400, according to an embodiment. An FCW 400 is composed of a fragment sequence number (FSN) field 402, a fragment size (FGS) field 404, a fragment position flag (FPF) field 406, and a unique tag (UT) field 408. Although the FCW 400 is illustrated as having a 32-bit length, it is understood that more or fewer bits may be used in the FCW 400. In the example illustrated in FIG. 4, bit 31 is a reserved bit.

The FSN field 402 is four bits and is a number ranging from 0 to N-1, where N is the number of fragments into which the segment has been divided, which indicates the position of the fragment within the segment itself, where 0 indicates the fragment positioned at the lowest addresses mapped by the segment while N-1 the highest ones. The number N depends on the size of the segment being divided into fragments.

The FGS field 404 is four bits and indicates the size (e.g., expressed in number of bytes) of the fragment. All fragments of a segment have the same size; however, segments of different size can be divided into fragments of different size.

The FPF field 406 is two bits and can take on three values indicating whether the fragment is the first fragment (e.g., fragment 0), the last fragment (e.g., fragment N-1), or an intervening fragment (e.g., one situated between the first and last fragments). For instance, the binary value 00 may indicate a first fragment, 11 may indicate a last fragment, and 01 may indicate an intervening fragment.

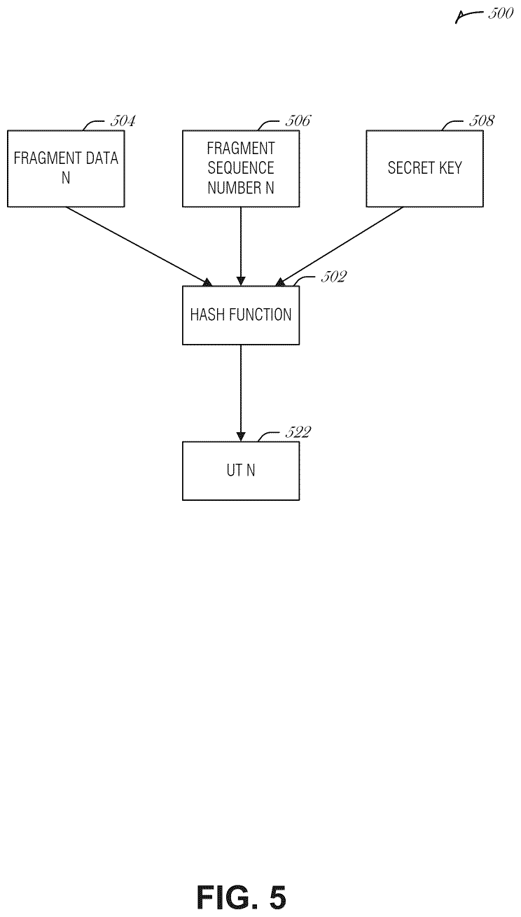

The UT field 408 is a unique identifier associated with each fragment into which the segment is divided. Here the UT field 408 is twenty-one bits, but it may be more or fewer. The unique identifier may be generated using the process 500 illustrated in FIG. 5.

The host populates the FSN, FGS, FPF, and UT fields (402, 404, 406, 408) and the device may use the fields to sort or reorder, validate, or perform other operations on the fragments.

FIG. 5 is a block diagram illustrating a process 500 for generating a unique tag (UT) 510 for an Nth fragment, according to an embodiment. A hash function 502 is used to hash the combination of fragment data 504 for fragment N, fragment sequence number 506 of fragment N, and a secret key 508 to obtain the UT 510 for fragment N. The secret key 508 is established between the host and the device, such as during an initialization stage, a handshaking stage, or through other channels. The secret key 508 may be a nonce or an arbitrary value. The secret key 508 may be used for all unique tags generated for fragments of a segment, or there may be separate secret keys used for each fragment/unique tag. The UT 510 is unique for each FCW so that data corruption, tampering, or other data anomalies may be detected easily by the device.

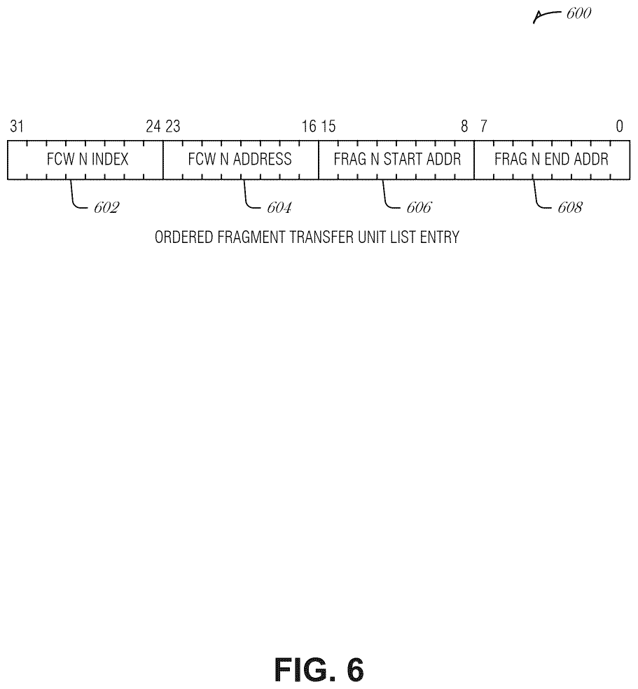

FIG. 6 is a block diagram illustrating a data structure of an ordered fragment transfer unit (FTU) list (OFL) 600, according to an embodiment. An entry in the OFL 600 is composed of an FCW N Index field 602, an FCW N Address field 604, a Fragment N Start Address field 606, and a Fragment N End Address field 608. Although the entry of the OFL 600 is illustrated as having a 32-bit length, it is understood that more or fewer bits may be used in the OFL 600 entry.

The FCW N Index field 602 is eight bits and contains an index of the FCW corresponding to the element of the OFL (generically indicated as n-th).

The FCW N Address field 604 is eight bits and contains an address of the FCW corresponding to the element of the OFL (generically indicated as n-th).

The Fragment N Start Address field 606 is eight bits and contains a starting address of the fragment corresponding to the FCW to which the element of the OFL refers (generically indicated as n-th).

Fragment N End Address field 608 is eight bits and contains an address of the end of the fragment corresponding to the FCW referred to by the element of the OFL (generically indicated as n-th).

There are as many entries in the OFL 600 as there are fragments from a segment. The OFL 600 is logically ordered based on the information stored in the FCWs, and its entries point to each of the fragments, which may be received out of order. This logical rearrangement re-orders the fragments back to their original order. The ordered OFL 600 is then used to generate the data transfer control list (DTCL).

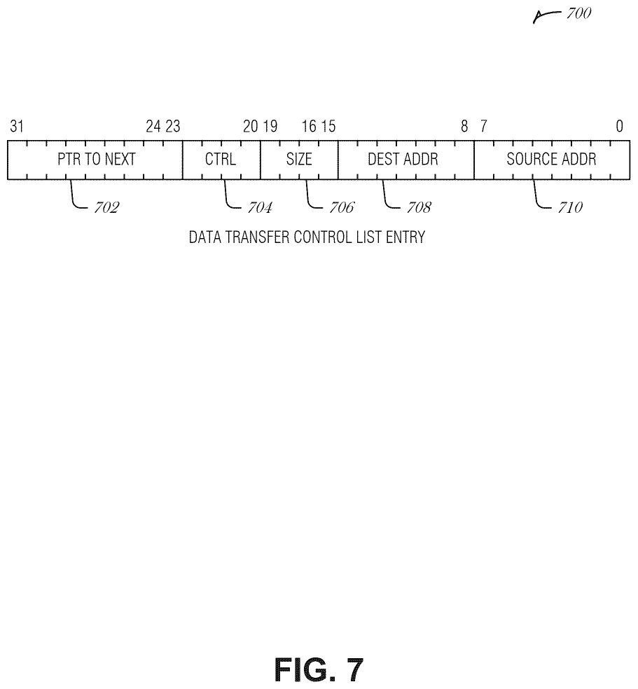

FIG. 7 is a block diagram illustrating a data structure of a data transfer control list (DTCL) entry 700, according to an embodiment. The DTCL entry 700 is composed of a Ptr to Next field 702, a Ctrl Word field 704, a Transfer Size field 706, a Destination Address field 708, and a Source Address field 710. Although the DTCL entry 700 is illustrated as having a 32-bit length, it is understood that more or fewer bits may be used in the DTCL entry 700.

The Ptr to Next field 702 is eight bits and contains a pointer to the next DTCL entry 700. The Ptr to Next field 702 may include an address to an address space in temporary memory (e.g., SRAM), such as a buffer.

The Ctrl Word field 704 is four bits and contains control information used by a memory controller to manage data transfer. The precise definition of this field depends on the actual implementation. Control bits may be used to control various actions of the memory controller, such as to generate an interrupt at the end of the data transfer described by the DTCL entry 700, decode the Ctrl Word field 704 to indicate whether it is the first, last or intermediate fragment, or initiate processing to be applied to the data being transferred to its destination (e.g., post-processing, AES encryption, AES decryption, etc.).

The Transfer Size field 706 is four bits and contains the total amount of the data (e.g., number of bytes) to be transferred in the operation controlled by the current DTCL entry 700.

The Destination Address field 708 is eight bits and contains a target address of the transfer controlled by the current DTCL entry 700. The destination address may be an address in an address space of a temporary memory (e.g., SRAM), such as a buffer.

The Source Address field 710 is eight bits and contains a source address of the transfer controlled by the current DTCL entry 700. The source address may be an address in the address space of a temporary memory (e.g., DRAM), such as a buffer.

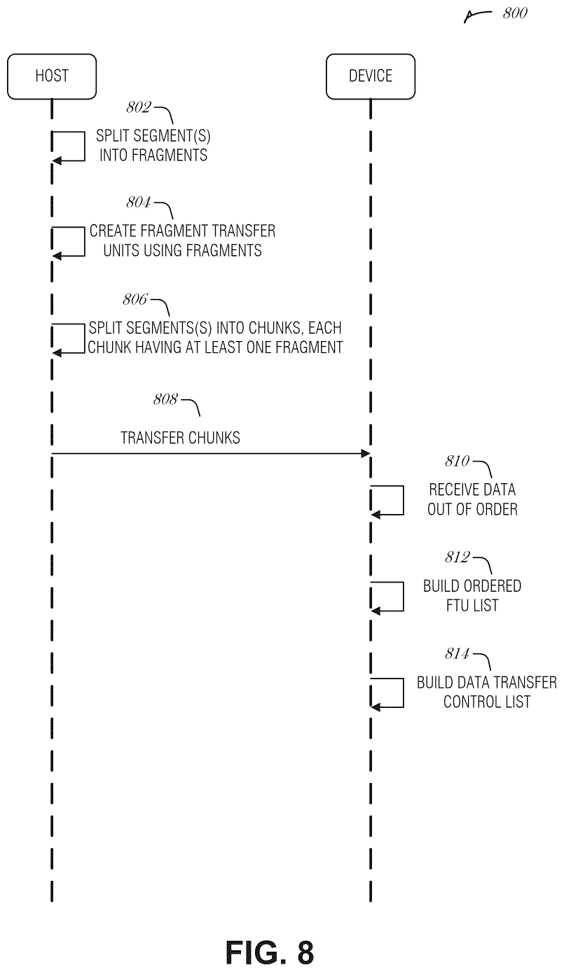

FIG. 8 is a swim lane diagram illustrating data and control flow of a method 800 to manage out-of-order data transfer, according to an embodiment. At 802, before transferring the data, the host splits each segment into a number N of fragments (e.g., eight in this example). At 804, the host creates a corresponding number of fragment transfer units (FTUs). Each FTU is composed of a single fragment and a corresponding fragment control word (FCW) (e.g., FCW 400 of FIG. 4). The FCW is initialized by the host, which populates fields FSN, FGS, and FPF, and then calculates the value for the UT field to insert into the FCW. The FCWs in the corresponding FTUs are populated with a fragment sequence number (e.g., fragment sequence number (FSN) field 402 of FIG. 4). The collection of ordered FTUs is considered a stuffed segment (e.g., stuffed segment 308 of FIG. 3).

At 806, the stuffed segment is split into chunks to be transferred via a sideband interface. At 808, the chunks are transferred from the host to the device via a sideband interface (e.g., SMBus). These chunks are received in the device in an out-of-order mode. The size of the stuffed segment and the size of the chunks are known between the host and device. For instance, the host and device may perform a handshake to negotiate and agree on stuffed segment size, chunk size, number of segments, number of chunks, number of fragments per chunk, etc. The division into chunks may be a result of and defined by the protocol that regulates data transmission through the sideband interface.

At 810, the device controller receives the data transfer out of order. The data may be received in a buffer memory (e.g., DRAM). After the transfer is complete, which may be indicated by receiving an agreed-upon number of segments, chunks, or the like, the device controller examines the un-ordered stuffed segment to locate the positions of the FCW and analyze its contents.

At 812, the device controller builds a list called Ordered FTU List (OFL) whose first OFL entry points to FTU 0, second OFL entry to FTU 1, . . . , and nth OFL entry to FTU N, thus logically reconstructing the original order of FTUs in the stuffed segment. Any type of sorting algorithm may be used. The OFL may be stored in the buffer memory.

At 814, using the OFL, the device controller builds a data structure called a data transfer control list (DTCL). The DTCL may be stored in the buffer memory. Each element of the DTCL contains the necessary information so that the device controller can manage the data transfer of the fragments contained in each FTU. The fragments may be stored in the buffer memory for additional processing, such as validation, to be performed on the completed firmware image. Once the FW file that contains the image is identified, it may be validated using a variety of mechanisms, such as by analyzing a digital signature that is included with the FW file. The FW image may be validated using a separate software process that performs a hash on the FW image, for example. After the FW file has been validated, the FW is loaded in the FW slot (e.g., stored in non-volatile memory).

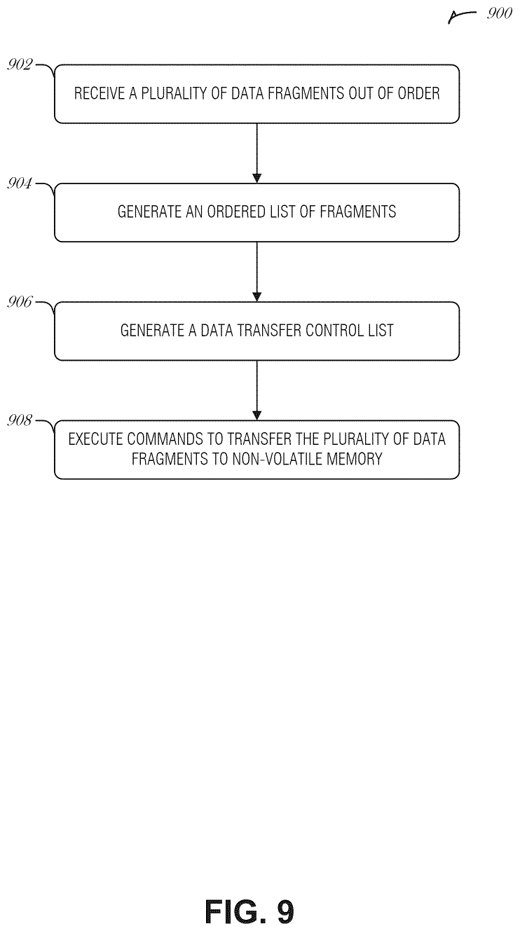

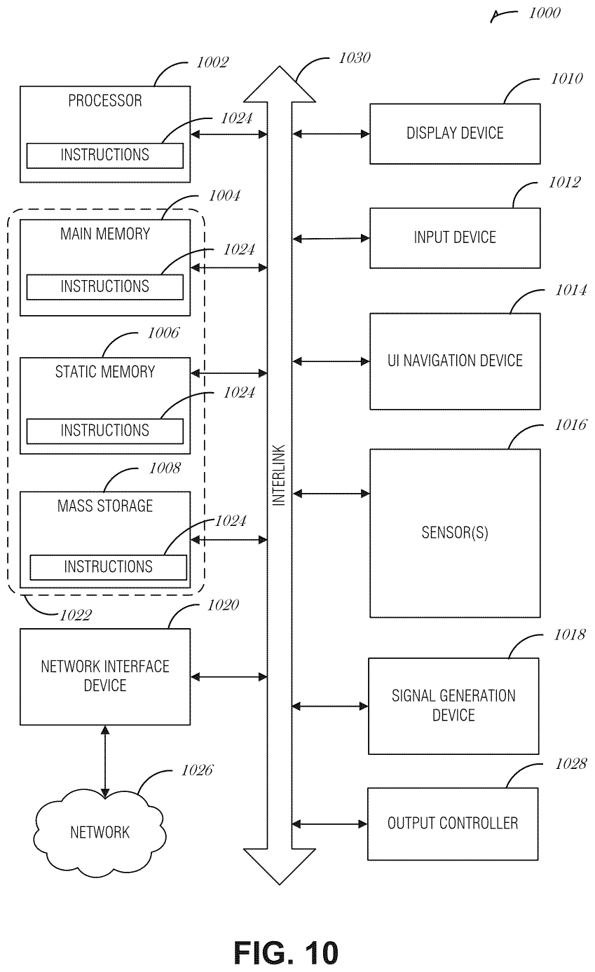

FIG. 9 is a flowchart illustrating an example method 900 for managing firmware programming in a device, according to an embodiment. The method 900 can be performed by processing logic that can include hardware (e.g., processing device, circuitry, dedicated logic, programmable logic, microcode, hardware of a device, integrated circuit, etc.). In various embodiments, the method 900 is performed by the controller 112 of FIG. 1, device logic and memory controller 224 of FIG. 2, or the hardware processor 1002 of FIG. 10.

At 902, the method 900 includes the operation of receiving into a buffer memory of a memory device, from a host device, a plurality of data fragments, the plurality of data fragments having an initial order that is different from the order received at the device, and the plurality of data fragments constituting a firmware image. In an embodiment, wherein receiving the plurality of data fragments includes receiving the plurality of data fragments over a sideband channel, such as SMBus.

At 904, the method 900 includes the operation of generating an ordered list of fragments using metadata stored in the plurality of data fragments, the ordered list of fragments including an entry for each of the plurality of fragments, and the ordered list of fragments providing a logical reordering of the plurality of data fragments back to the initial order.

In an embodiment, an entry in the ordered list of fragments comprises an index of a fragment control word corresponding to a position of the entry in the ordered list of fragments, an address of the fragment control word, a start address of a data fragment corresponding to the fragment control word, and an end address of the data fragment corresponding to the fragment control word.

In an embodiment, the method 900 includes identifying a plurality of fragment control words corresponding to each of the plurality of data fragments, and using a fragment control word of the plurality of fragment control words to generate the ordered list of fragments. In a further embodiment, the fragment control word includes a fragment sequence number, a fragment size, a fragment position flag, and a unique tag.

At 906, the method 900 includes the operation of generating a data transfer control list including an entry for each of the plurality of data fragments, each entry of the data transfer control list including instructions for the controller to transfer a corresponding data fragment to an address in a temporary memory using information stored in a corresponding entry in the ordered list of fragments.

In an embodiment, an entry in the data transfer control list comprises a pointer to a next entry in the data transfer control list, a control word, a transfer size, a destination address of data to be transferred, and a source address of the data to be transferred.

At 908, the method 900 includes the operation of executing commands to transfer the plurality of data fragments from the buffer memory to the temporary memory using data stored in the entries of the data transfer control list.

In an embodiment, the method 900 includes validating the plurality of data fragments before executing commands to transfer the plurality of data fragments from the buffer memory to the temporary memory using data stored in the entries of the data transfer control list. In a further embodiment, validating the plurality of data fragments includes calculating a hash value to obtain a hash result and comparing the hast result to the unique tag from a corresponding data fragment.

In an embodiment, the method 900 includes decrypting the plurality of data fragments before executing commands to transfer the plurality of data fragments from the buffer memory to the temporary memory using data stored in the entries of the data transfer control list.

FIG. 10 illustrates a block diagram of an example machine 1000 with which, in which, or by which any one or more of the techniques (e.g., methodologies) discussed herein can be implemented. Examples, as described herein, can include, or can operate by, logic or a number of components, or mechanisms in the machine 1000. Circuitry (e.g., processing circuitry) is a collection of circuits implemented in tangible entities of the machine 1000 that include hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional examples of these components with respect to the machine 1000.

In alternative embodiments, the machine 1000 can operate as a standalone device or can be connected (e.g., networked) to other machines. In a networked deployment, the machine 1000 can operate in the capacity of a server machine, a client machine, or both in server-client network environments. In an example, the machine 1000 can act as a peer machine in peer-to-peer (P2P) (or other distributed) network environment. The machine 1000 can be a personal computer (PC), a tablet PC, a set-top box (STB), a personal digital assistant (PDA), a mobile telephone, a web appliance, a network router, switch or bridge, embedded memory controller, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 1000 (e.g., computer system) can include a hardware processor 1002 (e.g., a central processing unit (CPU), a graphics processing unit (GPU), a hardware processor core, or any combination thereof), a main memory 1004, a static memory 1006 (e.g., memory or storage for firmware, microcode, a basic-input-output (BIOS), unified extensible firmware interface (UEFI), etc.), and mass storage device 1008 (e.g., hard drives, tape drives, flash storage, or other block devices) some or all of which can communicate with each other via an interlink 1030 (e.g., bus). The machine 1000 can further include a display device 1010, an alphanumeric input device 1012 (e.g., a keyboard), and a user interface (UI) Navigation device 1014 (e.g., a mouse). In an example, the display device 1010, the input device 1012, and the UI navigation device 1014 can be a touch screen display. The machine 1000 can additionally include a mass storage device 1008 (e.g., a drive unit), a signal generation device 1018 (e.g., a speaker), a network interface device 1020, and one or more sensor(s) 1016, such as a global positioning system (GPS) sensor, compass, accelerometer, or other sensor. The machine 1000 can include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the hardware processor 1002, the main memory 1004, the static memory 1006, or the mass storage device 1008 can be, or include, a machine-readable media 1022 on which is stored one or more sets of data structures or instructions 1024 (e.g., software) embodying or used by any one or more of the techniques or functions described herein. The instructions 1024 can also reside, completely or at least partially, within any of registers of the hardware processor 1002, the main memory 1004, the static memory 1006, or the mass storage device 1008 during execution thereof by the machine 1000. In an example, one or any combination of the hardware processor 1002, the main memory 1004, the static memory 1006, or the mass storage device 1008 can constitute the machine-readable media 1022. While the machine-readable media 1022 is illustrated as a single medium, the term “machine-readable medium” can include a single medium or multiple media (e.g., a centralized or distributed database, or associated caches and servers) configured to store the one or more instructions 1024.

The term “machine readable medium” can include any medium that is capable of storing, encoding, or carrying instructions for execution by the machine 1000 and that cause the machine 1000 to perform any one or more of the techniques of the present disclosure, or that is capable of storing, encoding, or carrying data structures used by or associated with such instructions. Non-limiting machine-readable medium examples can include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., electrically programmable read-only memory (EPROM), electrically erasable programmable read-only memory (EEPROM)) and flash memory devices; magnetic disks, such as internal hard disks and removable disks; magneto-optical disks; and CD-ROM and DVD-ROM disks.

In an example, information stored or otherwise provided on the machine-readable media 1022 can be representative of the instructions 1024, such as instructions 1024 themselves or a format from which the instructions 1024 can be derived. This format from which the instructions 1024 can be derived can include source code, encoded instructions (e.g., in compressed or encrypted form), packaged instructions (e.g., split into multiple packages), or the like. The information representative of the instructions 1024 in the machine-readable media 1022 can be processed by processing circuitry into the instructions to implement any of the operations discussed herein. For example, deriving the instructions 1024 from the information (e.g., processing by the processing circuitry) can include: compiling (e.g., from source code, object code, etc.), interpreting, loading, organizing (e.g., dynamically, or statically linking), encoding, decoding, encrypting, unencrypting, packaging, unpackaging, or otherwise manipulating the information into the instructions 1024.

In an example, the derivation of the instructions 1024 can include assembly, compilation, or interpretation of the information (e.g., by the processing circuitry) to create the instructions 1024 from some intermediate or preprocessed format provided by the machine-readable media 1022. The information, when provided in multiple parts, can be combined, unpacked, and modified to create the instructions 1024. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 1024 can be further transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), plain old telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1020 can include one or more physical jacks (e.g., Ethernet, coaxial, or phone jacks) or one or more antennas to connect to the network 1026. In an example, the network interface device 1020 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1000, and includes digital or analog communications signals or other intangible medium to facilitate communication of such software. A transmission medium is a machine readable medium.

To better illustrate the methods and apparatuses described herein, a non-limiting set of Example embodiments are set forth below as numerically identified Examples.

Example 1 is a device comprising: a temporary memory to store firmware images; and controller circuitry configured to: receive into a buffer memory, from a host device, a plurality of data fragments, the plurality of data fragments having an initial order that is different from the order received at the device, and the plurality of data fragments constituting a firmware image; generate an ordered list of fragments using metadata stored in the plurality of data fragments, the ordered list of fragments including an entry for each of the plurality of fragments, and the ordered list of fragments providing a logical reordering of the plurality of data fragments back to the initial order; generate a data transfer control list including an entry for each of the plurality of data fragments, each entry of the data transfer control list including instructions for the controller to transfer a corresponding data fragment to an address in the temporary memory using information stored in a corresponding entry in the ordered list of fragments; and execute commands to transfer the plurality of data fragments from the buffer memory to the temporary memory using data stored in the entries of the data transfer control list.

In Example 2, the subject matter of Example 1 includes, wherein the controller circuitry is configured to identify a plurality of fragment control words corresponding to each of the plurality of data fragments, and use a fragment control word of the plurality of fragment control words to generate the ordered list of fragments.

In Example 3, the subject matter of Example 2 includes, wherein the fragment control word comprises a fragment sequence number, a fragment size, a fragment position flag, and a unique tag.

In Example 4, the subject matter of Examples 1-3 includes, wherein an entry in the ordered list of fragments comprises an index of a fragment control word corresponding to a position of the entry in the ordered list of fragments, an address of the fragment control word, a start address of a data fragment corresponding to the fragment control word, and an end address of the data fragment corresponding to the fragment control word.

In Example 5, the subject matter of Examples 1-4 includes, wherein an entry in the data transfer control list comprises a pointer to a next entry in the data transfer control list, a control word, a transfer size, a destination address of data to be transferred, and a source address of the data to be transferred.

In Example 6, the subject matter of Examples 1-5 includes, wherein the controller circuitry is configured to validate the plurality of data fragments before executing commands to transfer the plurality of data fragments from the buffer memory to the temporary memory using data stored in the entries of the data transfer control list.

In Example 7, the subject matter of Example 6 includes, wherein the controller circuitry is configured to: validate the plurality of data fragments by calculating a hash value to obtain a hash result; and compare the hast result to the unique tag from a corresponding data fragment.

In Example 8, the subject matter of Examples 1-7 includes, wherein the controller circuitry is configured to decrypt the plurality of data fragments before executing commands to transfer the plurality of data fragments from the buffer memory to the temporary memory using data stored in the entries of the data transfer control list.

In Example 9, the subject matter of Examples 1-8 includes, wherein the controller circuitry is to receive the plurality of data fragments over a sideband channel.

Example 10 is a method comprising: receiving into a buffer memory of a memory device, from a host device, a plurality of data fragments, the plurality of data fragments having an initial order that is different from the order received at the device, and the plurality of data fragments constituting a firmware image; generating an ordered list of fragments using metadata stored in the plurality of data fragments, the ordered list of fragments including an entry for each of the plurality of fragments, and the ordered list of fragments providing a logical reordering of the plurality of data fragments back to the initial order; generating a data transfer control list including an entry for each of the plurality of data fragments, each entry of the data transfer control list including instructions for the controller to transfer a corresponding data fragment to an address in the temporary memory using information stored in a corresponding entry in the ordered list of fragments; and executing commands to transfer the plurality of data fragments from the buffer memory to the temporary memory using data stored in the entries of the data transfer control list.

In Example 11, the subject matter of Example 10 includes, identifying a plurality of fragment control words corresponding to each of the plurality of data fragments; and using a fragment control word of the plurality of fragment control words to generate the ordered list of fragments.

In Example 12, the subject matter of Example 11 includes, wherein the fragment control word comprises a fragment sequence number, a fragment size, a fragment position flag, and a unique tag.

In Example 13, the subject matter of Examples 10-12 includes, wherein an entry in the ordered list of fragments comprises an index of a fragment control word corresponding to a position of the entry in the ordered list of fragments, an address of the fragment control word, a start address of a data fragment corresponding to the fragment control word, and an end address of the data fragment corresponding to the fragment control word.

In Example 14, the subject matter of Examples 10-13 includes, wherein an entry in the data transfer control list comprises a pointer to a next entry in the data transfer control list, a control word, a transfer size, a destination address of data to be transferred, and a source address of the data to be transferred.

In Example 15, the subject matter of Examples 10-14 includes, validating the plurality of data fragments before executing commands to transfer the plurality of data fragments from the buffer memory to the temporary memory using data stored in the entries of the data transfer control list.

In Example 16, the subject matter of Example 15 includes, wherein validating the plurality of data fragments comprises: calculating a hash value to obtain a hash result; and comparing the hast result to the unique tag from a corresponding data fragment.

In Example 17, the subject matter of Examples 10-16 includes, decrypting the plurality of data fragments before executing commands to transfer the plurality of data fragments from the buffer memory to the temporary memory using data stored in the entries of the data transfer control list.

In Example 18, the subject matter of Examples 10-17 includes, wherein receiving the plurality of data fragments comprises receiving the plurality of data fragments over a sideband channel.

Example 19 is a non-transitory machine-readable medium including instructions, which when executed by a memory controller of a memory device, cause the memory controller to: receive into a buffer memory of the memory device, from a host device, a plurality of data fragments, the plurality of data fragments having an initial order that is different from the order received at the device, and the plurality of data fragments constituting a firmware image; generate an ordered list of fragments using metadata stored in the plurality of data fragments, the ordered list of fragments including an entry for each of the plurality of fragments, and the ordered list of fragments providing a logical reordering of the plurality of data fragments back to the initial order; generate a data transfer control list including an entry for each of the plurality of data fragments, each entry of the data transfer control list including instructions for the controller to transfer a corresponding data fragment to an address in the temporary memory using information stored in a corresponding entry in the ordered list of fragments; and execute commands to transfer the plurality of data fragments from the buffer memory to the temporary memory using data stored in the entries of the data transfer control list.

In Example 20, the subject matter of Example 19 includes, wherein the instructions cause the memory controller to identify a plurality of fragment control words corresponding to each of the plurality of data fragments, and use a fragment control word of the plurality of fragment control words to generate the ordered list of fragments.

In Example 21, the subject matter of Example 20 includes, wherein the fragment control word comprises a fragment sequence number, a fragment size, a fragment position flag, and a unique tag.

In Example 22, the subject matter of Examples 19-21 includes, wherein an entry in the ordered list of fragments comprises an index of a fragment control word corresponding to a position of the entry in the ordered list of fragments, an address of the fragment control word, a start address of a data fragment corresponding to the fragment control word, and an end address of the data fragment corresponding to the fragment control word.

In Example 23, the subject matter of Examples 19-22 includes, wherein an entry in the data transfer control list comprises a pointer to a next entry in the data transfer control list, a control word, a transfer size, a destination address of data to be transferred, and a source address of the data to be transferred.

In Example 24, the subject matter of Examples 19-23 includes, wherein the instructions cause the memory controller to validate the plurality of data fragments before executing commands to transfer the plurality of data fragments from the buffer memory to the temporary memory using data stored in the entries of the data transfer control list.

In Example 25, the subject matter of Example 24 includes, wherein the instructions cause the memory controller to: validate the plurality of data fragments by calculating a hash value to obtain a hash result; and compare the hast result to the unique tag from a corresponding data fragment.

In Example 26, the subject matter of Examples 19-25 includes, wherein the instructions cause the memory controller to decrypt the plurality of data fragments before executing commands to transfer the plurality of data fragments from the buffer memory to the temporary memory using data stored in the entries of the data transfer control list.

In Example 27, the subject matter of Examples 19-26 includes, wherein the instructions cause the memory controller to receive the plurality of data fragments over a sideband channel.

Example 28 is at least one machine-readable medium including instructions that, when executed by processing circuitry, cause the processing circuitry to perform operations to implement of any of Examples 1-27.

Example 29 is an apparatus comprising means to implement of any of Examples 1-27.

Example 30 is a system to implement of any of Examples 1-27.

Example 31 is a method to implement of any of Examples 1-27.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A device comprising:
a temporary memory to store firmware images; and
controller circuitry configured to:
receive into a buffer memory, from a host device, a plurality of data fragments, the plurality of data fragments having an initial order that is different from the order received at the device, and the plurality of data fragments constituting a firmware image;
generate an ordered list of fragments using metadata stored in the plurality of data fragments, the ordered list of fragments including an entry for each of the plurality of fragments, and the ordered list of fragments providing a logical reordering of the plurality of data fragments back to the initial order;
generate a data transfer control list including an entry for each of the plurality of data fragments, each entry of the data transfer control list including instructions for the controller to transfer a corresponding data fragment to an address in the temporary memory using information stored in a corresponding entry in the ordered list of fragments; and
execute commands to transfer the plurality of data fragments from the buffer memory to the temporary memory using data stored in the entries of the data transfer control list.

2. The device of claim 1, wherein the controller circuitry is configured to identify a plurality of fragment control words corresponding to each of the plurality of data fragments, and use a fragment control word of the plurality of fragment control words to generate the ordered list of fragments.

3. The device of claim 2, wherein the fragment control word comprises a fragment sequence number, a fragment size, a fragment position flag, and a unique tag.

4. The device of claim 1, wherein an entry in the ordered list of fragments comprises an index of a fragment control word corresponding to a position of the entry in the ordered list of fragments, an address of the fragment control word, a start address of a data fragment corresponding to the fragment control word, and an end address of the data fragment corresponding to the fragment control word.

5. The device of claim 1, wherein an entry in the data transfer control list comprises a pointer to a next entry in the data transfer control list, a control word, a transfer size, a destination address of data to be transferred, and a source address of the data to be transferred.

6. The device of claim 1, wherein the controller circuitry is configured to validate the plurality of data fragments before executing commands to transfer the plurality of data fragments from the buffer memory to the temporary memory using data stored in the entries of the data transfer control list.

7. The device of claim 6, wherein the controller circuitry is configured to:
validate the plurality of data fragments by calculating a hash value to obtain a hash result; and
compare the hast result to the unique tag from a corresponding data fragment.

8. The device of claim 1, wherein the controller circuitry is configured to decrypt the plurality of data fragments before executing commands to transfer the plurality of data fragments from the buffer memory to the temporary memory using data stored in the entries of the data transfer control list.

9. The device of claim 1, wherein the controller circuitry is to receive the plurality of data fragments over a sideband channel.

10. A method comprising:
receiving into a buffer memory of a memory device, from a host device, a plurality of data fragments, the plurality of data fragments having an initial order that is different from the order received at the device, and the plurality of data fragments constituting a firmware image;
generating an ordered list of fragments using metadata stored in the plurality of data fragments, the ordered list of fragments including an entry for each of the plurality of fragments, and the ordered list of fragments providing a logical reordering of the plurality of data fragments back to the initial order;
generating a data transfer control list including an entry for each of the plurality of data fragments, each entry of the data transfer control list including instructions for the controller to transfer a corresponding data fragment to an address in the temporary memory using information stored in a corresponding entry in the ordered list of fragments; and
executing commands to transfer the plurality of data fragments from the buffer memory to the temporary memory using data stored in the entries of the data transfer control list.

11. The method of claim 10, comprising:
identifying a plurality of fragment control words corresponding to each of the plurality of data fragments; and
using a fragment control word of the plurality of fragment control words to generate the ordered list of fragments.

12. The method of claim 11, wherein the fragment control word comprises a fragment sequence number, a fragment size, a fragment position flag, and a unique tag.

13. The method of claim 10, wherein an entry in the ordered list of fragments comprises an index of a fragment control word corresponding to a position of the entry in the ordered list of fragments, an address of the fragment control word, a start address of a data fragment corresponding to the fragment control word, and an end address of the data fragment corresponding to the fragment control word.

14. The method of claim 10, wherein an entry in the data transfer control list comprises a pointer to a next entry in the data transfer control list, a control word, a transfer size, a destination address of data to be transferred, and a source address of the data to be transferred.

15. The method of claim 10, comprising validating the plurality of data fragments before executing commands to transfer the plurality of data fragments from the buffer memory to the temporary memory using data stored in the entries of the data transfer control list.

16. The method of claim 15, wherein validating the plurality of data fragments comprises:
calculating a hash value to obtain a hash result; and
comparing the hast result to the unique tag from a corresponding data fragment.

17. The method of claim 10, comprising decrypting the plurality of data fragments before executing commands to transfer the plurality of data fragments from the buffer memory to the temporary memory using data stored in the entries of the data transfer control list.

18. The method of claim 10, wherein receiving the plurality of data fragments comprises receiving the plurality of data fragments over a sideband channel.

19. A non-transitory machine-readable medium including instructions, which when executed by a memory controller of a memory device, cause the memory controller to:
receive into a buffer memory of the memory device, from a host device, a plurality of data fragments, the plurality of data fragments having an initial order that is different from the order received at the device, and the plurality of data fragments constituting a firmware image;
generate an ordered list of fragments using metadata stored in the plurality of data fragments, the ordered list of fragments including an entry for each of the plurality of fragments, and the ordered list of fragments providing a logical reordering of the plurality of data fragments back to the initial order;
generate a data transfer control list including an entry for each of the plurality of data fragments, each entry of the data transfer control list including instructions for the controller to transfer a corresponding data fragment to an address in the temporary memory using information stored in a corresponding entry in the ordered list of fragments; and
execute commands to transfer the plurality of data fragments from the buffer memory to the temporary memory using data stored in the entries of the data transfer control list.

20. The non-transitory machine-readable medium of claim 19, wherein the instructions cause the memory controller to identify a plurality of fragment control words corresponding to each of the plurality of data fragments, and use a fragment control word of the plurality of fragment control words to generate the ordered list of fragments.
